(19) United States
(12) Patent Application Publication
(10) Pub. No.: US 2009/0259991 A1
(43) Pub. Date: Oct. 15, 2009

(54) METHOD AND APPARATUS FOR PROCESSING CONFIGURATION INFORMATION AND A PLATFORM SYSTEM

(75) Inventor: Hong MU, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/492,331

(22) Filed: Jun. 26, 2009

Related U.S. Application Data
(63) Continuation of application No. PCT/CN2008/070640, filed on Mar. 31, 2008.

(30) Foreign Application Priority Data
Apr. 29, 2007 (CN) 200710103021.6

(51) Int. Cl. G06F 9/44; G06F 9/46

(52) U.S. Cl. 717/121; 717/120; 719/318; 707/3; 707/E17.014

(57) ABSTRACT

A configuration information processing method includes: receiving a policy identifier sent by a user, where the policy identifier represents the configuration information which the user requests to obtain; obtaining the source information and combination policy information according to the policy identifier; searching for the corresponding configuration sources according to the source information; and combining the configuration sources into a uniform configuration source according to the combination policy information. A configuration information processing apparatus includes: a policy identifier receiving unit, an information obtaining unit, a configuration source querying unit, and a configuration source combining unit. A platform system includes: a user operation interface, a configuration information processing apparatus, and a configuration generating unit. The configuration generating unit is adapted to develop or customize platform configuration information requested by the user according to the combined uniform configuration source. The embodiments of the present disclosure improve the flexibility of platform customization effectively, and implement upgrade and customization of platform products conveniently.

### CROSS-REFERENCE TO RELATED APPLICATIONS

This application is a continuation of International Patent Application No. PCT/CN2008/070640, filed Mar. 31, 2008, which claims priority to Chinese Patent Application No. 200710103021.6, filed Apr. 29, 2007, both of which are hereby incorporated by reference in their entirety.

### FIELD OF THE INVENTION

The present disclosure relates to the field of data processing, and in particular, to a method and apparatus for processing configuration information and a platform system.

### BACKGROUND

In developing application software of large scale the configuration files are characterized by a large quantity, diversified formats and many different storage locations, which bring huge inconvenience to the installation, deployment, upgrade and customized development of software.

A method for processing configuration information in the conventional art is: (1) managing configuration information through a database; and (2) storing the content of the configuration information into the database.

A platform system allows the user to combine software components or perform other simple operations as required to develop and customize software. Generally, the platform system has multiple functional modules, and each functional module has corresponding default configuration information. When developing and customizing the software, the user generally changes the configuration information to implement the required functions.

Another method for processing configuration information in the conventional art is: (1) storing the configuration information into a configuration file; and (2) reading the corresponding configuration file, when the user needs to obtain configuration information.

In a process of researching the present disclosure, the inventor finds at least the following defects in the conventional art.

The solution in the conventional art has a unitary configuration source, namely, each configuration file stores the corresponding configuration information. When the user needs to obtain the configuration information, the user searches the corresponding file firstly and then reads the configuration information from the configuration file. Therefore, when the user changes the configuration information, the configuration file that carries the default configuration information of the platform system may be overwritten. Moreover, if the platform system is upgraded, the configuration information is upgraded accordingly. Therefore, the old configuration information is overwritten, which leads to errors when the user operates the configuration information again. Consequently, the user has to set the configuration again, which increases the complexity of the platform customization.

### SUMMARY

Embodiments of the present disclosure provide a method for processing configuration information, a platform system, and an apparatus for processing configuration information to improve the convenience of platform customization.

A method for processing configuration information in an embodiment of the present disclosure includes: (1) receiving a policy identifier sent by a user, where the policy identifier represents configuration information which the user requests to obtain; (2) obtaining source information and combination policy information according to the policy identifier; (3) searching for corresponding configuration sources according to the source information; and (4) combining the configuration sources into a uniform configuration source according to the combination policy information.

An apparatus for processing configuration information in an embodiment of the present disclosure includes: (1) a policy identifier receiving unit, adapted to receive a policy identifier which represents configuration information which the user requests to obtain; (2) an information obtaining unit, adapted to obtain corresponding source information and combination policy information according to the policy identifier received by the policy identifier receiving unit; (3) a configuration source querying unit, adapted to query and obtain a corresponding configuration source according to the source information obtained by the information obtaining unit; and (4) a configuration source combining unit, adapted to combine found configuration sources into a uniform configuration source according to the combination policy information obtained by the information obtaining unit.

A platform system provided in an embodiment of the present disclosure includes: (1) a user operation interface, adapted to receive a configuration request carrying a policy identifier from the user; (2) a configuration information processing apparatus, adapted to combine configuration sources that carry configuration information into a uniform configuration source according to the policy identifier in the configuration request; and (3) a configuration generating unit, adapted to develop or customize platform configuration information requested by the user according to the combined uniform configuration source.

According to the embodiments of the present disclosure, the result of combining multiple configuration sources is used as a configuration source, and basic configuration information is set while a fundamental version of the product is developed. In each customized version, only customized files need to be added without modifying the basic configuration information, and the configuration is obtained through combining. Therefore, the ultimate configuration information carries the original configuration information and the updated configuration information so that the platform product may be upgraded and customized conveniently.

### BRIEF DESCRIPTION OF THE DRAWINGS

FIG. 1 shows a platform system according to an embodiment of the present disclosure;

FIG. 2 shows a platform system according to an embodiment of the present disclosure;

FIG. 3 shows a configuration information processing apparatus according to an embodiment of the present disclosure; and

FIG. 4 is a flowchart of a configuration information processing method according to an embodiment of the present disclosure.

### DETAILED DESCRIPTION

Embodiments of the present disclosure provide a method and apparatus for processing configuration information, and a platform system to implement platform upgrade and customization conveniently.

First, the platform system according to an embodiment of the present disclosure is described below.

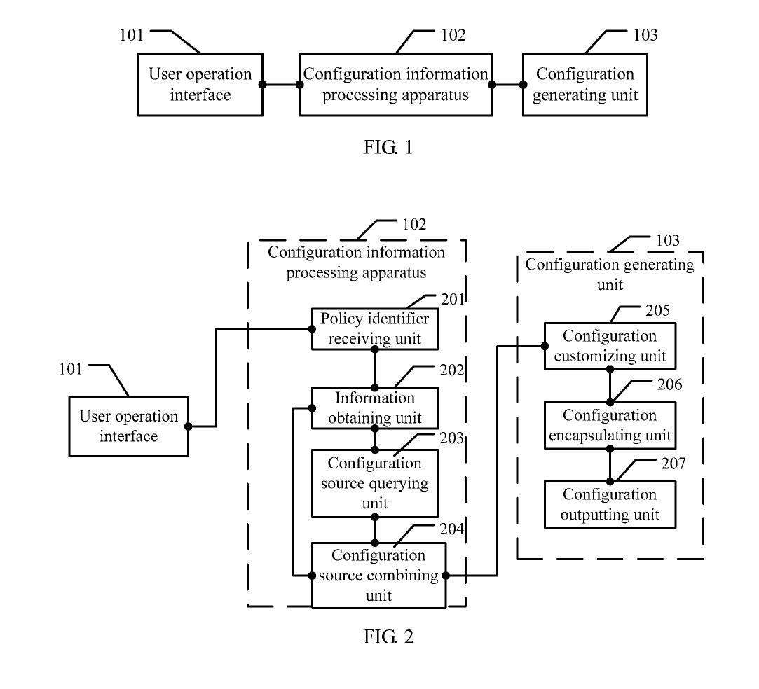

As shown in FIG. 1, the platform system according to an embodiment of the present disclosure may include a user operation interface 101, a configuration information processing apparatus 102 and a configuration generating unit 103.

The user operation interface 101 is adapted to receive a user configuration request that carries the information on the type of the platform (for example, software or hardware) expected by the user to develop or customize, and contents and functions of the platform, where one platform is generally composed of multiple functional modules, and each functional module has corresponding configuration information. The configuration request may carry a policy identifier that represents the configuration information which the user requests to obtain.

The configuration information processing apparatus 102 is adapted to combine configuration sources that carry configuration information into a uniform configuration source according to the policy identifier in the configuration request.

The configuration generating unit 103 is adapted to develop or customize platform configuration information requested by the user according to the combined uniform configuration source.

As shown in FIG. 2, according to an embodiment of the present disclosure, the configuration information processing apparatus 102 may include a policy identifier receiving unit (201) 201, an information obtaining unit 202, a configuration source querying unit 203 and a configuration source combining unit 204.

The policy identifier receiving unit 201 is adapted to receive a policy identifier.

The information obtaining unit 202 is adapted to obtain corresponding source information and combination policy information according to the received policy identifier.

The configuration source querying unit 203 is adapted to query a corresponding configuration source according to the obtained source information.

The configuration source combining unit 204 is adapted to combine found configuration sources into a uniform configuration source according to the obtained combination policy information.

Specifically, the configuration generating unit 103 may include a configuration customizing unit 205, a configuration encapsulating unit 206 and a configuration outputting unit 207.

The configuration customizing unit 205 is adapted to configure a uniform configuration source obtained from the configuration source combining unit 204 as requested by the user.

The configuration encapsulating unit 206 is adapted to encapsulate a configured functional module to form ultimate configuration information.

The configuration outputting unit 207 is adapted to output the ultimate configuration information. In this embodiment, after the functional module is encapsulated into a data structure, a user interface is set to output the ultimate configuration.

A configuration information processing apparatus in another embodiment of the present disclosure is described below:

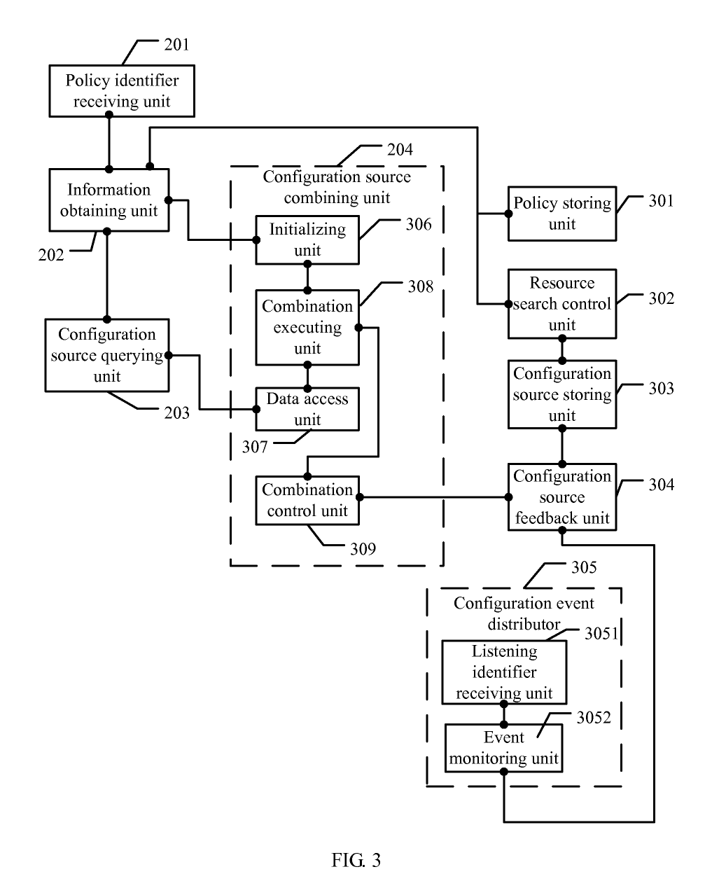

As shown in FIG. 3, according to this embodiment, the configuration information processing apparatus 102 may include a policy identifier receiving unit 201, an information obtaining unit 202, a configuration source querying unit 203 and a configuration source combining unit 204.

The policy identifier receiving unit 201 is adapted to receive a policy identifier that represents configuration information which the user requests to obtain.

The information obtaining unit 202 is adapted to obtain corresponding source information and combination policy information according to the received policy identifier.

The configuration source querying unit 203 is adapted to query and obtain a corresponding configuration source according to the obtained source information.

The configuration source combining unit 204 is adapted to combine found configuration sources into a uniform configuration source according to the obtained combination policy information.

In this embodiment, the configuration information processing apparatus 102 may further include a policy storing unit 301, a resource search control unit 302, a configuration source storing unit 303 and a configuration source feedback unit 304.

The policy storing unit 301 is adapted to store combination policy information capable of providing combination rules. The information obtaining unit 202 may query the corresponding combination policy information in the policy storing unit 301 according to the received policy identifier.

The resource search control unit 302 is adapted to receive the source information obtained by the information obtaining unit 202, forward the source information to the configuration source querying unit 203, and request the configuration source querying unit 203 to query the configuration source corresponding to the source information.

The configuration source storing unit 303 is adapted to store the configuration sources and the combined uniform configuration source.

The configuration source querying unit 203 searches the configuration source storing unit 303 for the configuration source corresponding to the source information. The configuration source combining unit 204 combines the configuration sources into a uniform configuration source, and stores the uniform configuration source into the configuration source storing unit 303.

The configuration source feedback unit 304 is adapted to feed back the combined uniform configuration source to the user who requests the configuration source.

In this embodiment, the configuration information processing apparatus 102 may further include a configuration event distributor 305 which may further include a listening identifier receiving unit 3051 and an event monitoring unit 3052.

The listening identifier receiving unit 3051 is adapted to receive the event listening identifier from the user, and send the identifier to the event monitoring unit 3052.

The event monitoring unit 3052 is adapted to monitor the configuration event according to the received event listening identifier to check whether the configuration event fulfills the preset conditions in the event listening identifier; and, if the preset conditions are fulfilled, the event monitoring unit 3052 request the configuration source feedback unit 304 to feed back the current configuration source to the user.

The preset conditions may include the configuration source changes, or the configuration changes due to initiative invocation of the configuration modification interface.

The configuration source combining unit 204 may include an initializing unit 306, a data access unit 307, a combination executing unit 308 and a combination control unit 309.

The initializing unit 306 is adapted to perform initialization according to the combination policy information. The initialization process is setting various combination parameters, for example, type of data to be processed—“XML”, type of the configuration source formed after combination—“DOM.” The specific parameters and the method of setting the parameters depend on the actual conditions and are not restricted herein.

The data access unit 307 is adapted to obtain the data to be combined in the configuration source, and send the data to the combination executing unit 308.

The combination executing unit 308 is adapted to combine the obtained data that needs combination according to the combination policy information.

The combination control unit 309 is adapted to check for completion of combining the data to be combined, and generate a judgment result.

Depending on the judgment result, if the combination is completed, the combination control unit 309 returns the ultimate combined data. If the combination is not completed, the combination control unit 309 instructs the combination executing unit 308 to continue processing the data to be combined.

The configuration information processing apparatus according to the embodiments of the present disclosure is described in detail above. It is understandable that the functional units described above may be integrated into one unit in practice, for example:

1. The policy identifier receiving unit 201 and the configuration source feedback unit 304 are integrated into a configuration policy manager. The configuration policy manager provides other functions, including: forwarding the source information to the resource search control unit 302 according to the received policy identifier; searching for the corresponding policy information according to the received policy identifier; and searching for the corresponding combination policy information according to the policy information.

2. The configuration source querying unit 203 and the configuration source storing unit 303 may be integrated into a configuration resource manager. That is, the configuration resource manager is adapted to receive the source information from the resource search control unit 302, query the corresponding configuration source in the locally stored configuration sources according to the source information, and feed back the found configuration sources to the resource search control unit 302.

Described above are two types of unit integration. It is understandable that in practice, other forms of integration may exist, and the form of integration is not limited herein. For ease of description, the following description on the embodiments of the method supposes that the aforementioned integration form applies. That is, the configuration information processing apparatus includes a configuration policy manager, a resource search control unit, a configuration resource manager, a policy storing unit, a configuration source combining unit, a configuration source feedback unit and a configuration event distributor.

According to the embodiments of the present disclosure, the configuration information processing apparatus may use the result of combining multiple configuration sources as a uniform configuration source, and set basic configuration information when developing the fundamental version of the product. In each customized version, only customized files need to be added without modifying the basic configuration information, and the configuration is obtained through combining. Therefore, a configuration source includes the original configuration information and the updated configuration information so that the platform product may be upgraded and customized conveniently. The configuration information processing method according to an embodiment of the present disclosure is described in detail as below by reference to the aforementioned configuration information processing apparatus. In order to describe the configuration information processing method more clearly, the following description involves a practical example, and supposes that the uniform configuration policy file is “uconfig.xml”, where the policy identifier is “sql.” This policy uses two files “default-sql.xml” and “customization-sql.xml” as configuration sources, uses “sql.xslt” as a combination template, and uses Extensible Style sheet Language Transformation (XSLT) as a combination engine. The objective is to combine two files into a configuration information data structure of the Document Object Model (DOM) format.

The contents of the uconfig.xml file are as follows:

<policies>
<policy id=“sql”>
<default type=“xml”>f:/conf/default-sql.xml</default>
<extension type=“xml”>f:/ext/conf/customizations-sql.xml</extension>
<merge-template>sql.xslt</merge-template>
<engine-type>xslt</engine-type>
<policies>

The meanings of the file are as follows.

In this file, the policy identifier is “sql”, the file type is “xml”, the default configuration file path (namely, a configuration source) is “f:/conf/default-sql.xml”, the configuration file path configured by the user (namely, another configuration source) is “f:/ext/conf/customizations-sql.xml”, and the combination template is “sql.xslt.” The combination template indicates the combination rules. In this embodiment, the specific combination rules are that if the ID is the same in the nodes, the value in “customization-sql” applies. For the remaining nodes, the two files are combined.

The contents of the default-sql.xml file are as follows:

<configures>
<configure id=“sql1”>
<sql>select * from function where funciton.id=‘1’</sql>
<configure>
<configure id=“sql2”>
<sql>select * from customers</sql>
<configure>
<configures>

The meanings of the file are that if the ID of the functional node in the software is “sql1”, the SQL statement “select * from function where funciton.id=‘1’” is executed. If the node ID is “sql2”, the SQL statement “select * from customers” is executed.

The aforementioned node ID is a parameter in the functional module of the software.

The contents of the customization-sql.xml file are as follows:

<configures>
<configure id=“sql1”>
<sql>select * from function where funciton.id=‘2’</sql>
<configure>
<configures>

The rough meanings of the file are that If the ID is “sql1”, the SQL statement “select * from function where function.id=‘2’” is executed.

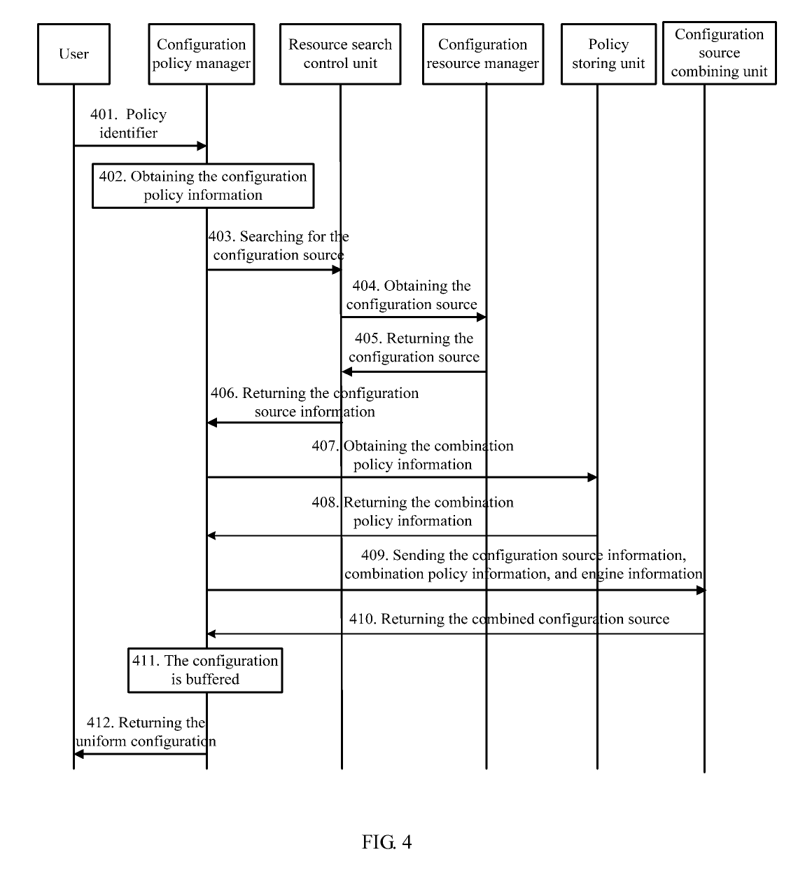

As shown in FIG. 4, the configuration information processing method according to an embodiment of the present disclosure includes the following steps. In the following description, the executor of all steps is the configuration information processing apparatus:

401. Receiving a policy identifier.

A configuration policy manager in the configuration information processing apparatus receives the policy identifier sent by the user, where the policy identifier represents the uniform configuration information which the user requests to obtain.

In this embodiment, the user sends a policy identifier “sql” to the configuration policy manager to obtain uniform configuration information.

402. Obtaining the configuration policy information.

After receiving the policy identifier sent by the user, the configuration policy manager queries the policy information corresponding to the policy identifier among the locally stored corresponding rule.

The corresponding rule mentioned above is the corresponding relationship between the policy identifier and the policy information.

The obtained policy information may primarily include the source information, for example, information on which files combine into ultimate configuration information.

In this embodiment, the configuration policy manager searches for the source information, and the source information corresponding to the “sql” identifier is “f:/conf/default-sql.xml” and “f:/ext/conf/customization-sql.xml.”

403. Searching for the configuration source.

After finding the source information, the configuration policy manager sends a request of the found source information to the resource search control unit to search for the configuration source.

In this embodiment, the configuration policy manager sends the source information “f:/conf/default-sql.xml” and “f:/ext/conf/customization-sql.xml” and the configuration source type “xml” to the resource search control unit.

404. Obtaining the configuration source.

According to different configuration resource types, the resource search control unit forwards the received source information to the corresponding configuration resource manager, requesting the configuration resource manager to query the configuration source.

In this embodiment, the resource search control unit forwards the request of searching for the specific resource information to the configuration resource manager of the file type, where the request carries the source information and specifies the file type to be “xml.”

405. Returning the configuration source.

The configuration resource manager finds the corresponding configuration source, and returns the configuration source to the resource search control unit.

In this embodiment, the configuration resource manager searches the file system for the file, and obtains the URL of the file and returns it to the resource search control unit.

406. Returning the configuration source information.

The resource search control unit receives the configuration sources sent by each resource manager, aggregates the configuration sources, and returns them to the configuration policy manager.

In this embodiment, the resource search control unit encapsulates “f:/conf/default-sql.xml” and “f:/ext/conf/customization-sql.xml” into a uniform resource type. The resource type includes the following information: URL, file type, existence or non-existence, and description information. The converted resource is returned to the configuration policy manager. The specific encapsulation process is performed according to the conventional art, and is not repeated here any further.

407. Obtaining the combination policy information.

According to the obtained policy information, the configuration policy manager searches the policy storing unit for the corresponding combination policy information.

In this embodiment, the combination policy information is a policy template, namely, “sql.xslt.” It is possible that the template needs to be processed, for example, the parameters are processed into a uniform format.

408. Returning the combination policy information.

As requested by the configuration policy manager, the policy storing unit finds the corresponding combination policy information and feeds back it to the configuration policy manager.

In this embodiment, the policy storing unit sends the processed “sql.xslt” to the configuration policy manager.

409. Sending the configuration source information, combination policy information, and engine information.

The configuration policy manager sends the configuration source information received from the resource search control unit, the combination policy information received from the policy storing unit, and the engine information in the policy information, to the configuration source combining unit.

In this embodiment, the configuration policy manager sends the obtained configuration source, the policy template “sql.xslt” and the engine information in the policy information (here the specified engine is “xslt”) to the configuration source combining unit. The policy adopted by the “sql.xslt” here is that if the ID is the same in the nodes, the value in the “customization-sql” is applied. For the remaining nodes, the two files are combined.

410. Returning the combined configuration source.

The configuration source combining unit combines the configuration sources, and returns the combined uniform configuration source to the configuration policy manager.

The specific combination process is as follows.

1. The configuration source combining unit accesses the configuration source, and obtains one of the data as datum A to be combined. If only one configuration source is available, the data of the configuration resource are returned directly. If more than one configuration source is available, the process proceeds to step 2.

2. From the configuration source, the second datum is obtained as datum B to be combined.

3. The configuration source combining unit searches for the corresponding combination algorithm engine according to the engine information, and uses the policy template to initialize the engine. The initialization process is used for setting the engine parameters. The specific parameters and the method of setting the parameters depend on the actual conditions, and are not limited herein.

4. The datum A and datum B to be combined are sent to the configuration source combining unit, and the engine makes the data be combined according to the policy template information and uses the combination result as datum A to be combined.

5. The next datum in the resource collection is obtained as datum B to be combined, and step 4 and step 5 recur until the resource collection is traversed completely.

6. Finally, datum A to be combined is returned as a result.

In this embodiment, the configuration source combining unit uses the corresponding xslt engine to combine the two received configuration sources into a uniform configuration source, and returns the DOM data configured by the “sql” policy. The specific combination process is the same as described above.

411. Buffering the configuration.

The configuration policy manager instructs the configuration source storing unit to buffer the combined data. Therefore, when the user requests for the same configuration again, the data in the buffer can be returned directly, without combining the data again.

In this embodiment, the configuration policy manager instructs the configuration source storing unit to buffer the combined DOM data. Therefore, the configuration is unified; and, when the user requests for the same configuration again, the data in the buffer may be returned directly, without combining the data again.

412. Returning the uniform configuration.

The configuration policy manager instructs the configuration source feedback unit to return the combined data to the user.

In this embodiment, the configuration policy manager instructs the configuration source feedback unit to return the combined data to the uniformly configured user, and the returned DOM data are as follows:

<configures>
<configure id=“sql1”>
<sql>select * from function where funciton.id=‘2’</sql>
<configure>
<configure id=“sql2”>
<sql>select * from customers</sql>
<configure>
<configures>

In the default-sql, if the node ID is “sql1”, the SQL statement “select * from function where funciton.id=‘1’” is executed. If the node ID in the customization-sql is “sql1”, the SQL statement “select * from function where funciton.id=‘2’” is executed. According to the policy applied to the “sql.xslt”, namely, “if the ID is the same in the nodes, the value in the customization-sql is applied; for the remaining nodes, two files are combined”, the value in the customization-sql file is applied if the node ID is the same. In this embodiment, therefore, if the node ID is “sql1”, the SQL statement “select * from function where funciton.id=‘2’” is executed, and the remaining parts combined are that if the node ID is “sql2”, the SQL statement “select * from customers” is executed.

In this embodiment, the sequence of performing step 407 and step 408 in the process is adjustable according to the actual conditions. For example, step 407 and step 408 may be performed after the configuration policy manager obtains the source information, which also accomplishes the objectives of the present disclosure. Step 411 is a step in the preferred solution, and is optional. Omission of step 411 does not affect fulfillment of the objectives of the present disclosure.

Moreover, before, after or during step 401 in this embodiment, the user may send an event listening identifier carrying preset conditions to the configuration event distributor, requesting to monitor the event and notify the user when the preset conditions are fulfilled.

After the configuration source combining unit combines all configuration sources into a uniform configuration source, or after the configuration event distributor receives the event listening identifier from the user, the configuration event distributor monitors the event upon completion of registering the event listening identifier of the user. Once the preset conditions are fulfilled as monitored, the configuration event distributor notifies the user.

The preset conditions may be the current configuration source changes, or the specified triggering time arrives.

If the configuration source changes, the configuration event distributor sends the updated configuration information to the user, and the user loads the configuration again according to the received updated configuration information.

In this embodiment, the combined data is buffered, which improves the efficiency of the user obtaining the configuration information. Moreover, the data storage is separated from data use, which improves the extensibility of the data storage.

Further, the engine-based combination mode is applied in this embodiment. Therefore, different uniform configuration requirements are fulfilled only by adjusting the engine mode and using different combination policy information, thus improving the flexibility of configuration combination.

Further still, a configuration event distributor is set in this embodiment. Therefore, the user may set the triggering identifier. When the configuration changes, the configuration event distributor sends the changed configuration information to the user proactively, thus improving the flexibility of the user obtaining the configuration information.

Finally, a “secondary search” mechanism is applied to the search for source information in this embodiment. That is, the resource search control unit receives the query request and forwards it to the resource manager for searching, and the feedback information from the resource manager is aggregated and sent to the configuration policy manager. Therefore, the processing performance of all units is improved effectively, and the performance of the whole system is improved accordingly.

It is understandable to those skilled in the art that all or partial steps of the foregoing embodiments may be implemented through hardware instructed by programs. The programs may be stored in a computer readable storage medium. When such programs are running, the process includes: receiving the policy identifier from the user; obtaining the source information and combination policy information according to the policy identifier; searching for the configuration sources corresponding to the source information; and combining the configuration sources into a uniform configuration source according to the combination policy information. The storage medium mentioned above may be a Read-Only Memory (ROM), magnetic disk or Compact Disk (CD).

Detailed above are a method and apparatus for processing configuration information as well as a platform system in preferred embodiments of the present disclosure. The specific implementation mode and application scope of the present disclosure may vary based on the ideas of the embodiments of the present disclosure, and the embodiments described herein are not intended to limit the present disclosure.

What is claimed is:

1. A configuration information processing method, comprising:
receiving from a user a policy identifier indicative of configuration information requested by the user;
obtaining source information and combination policy information according to the policy identifier;
searching for corresponding configuration sources according to the source information; and
combining the configuration sources into a uniform configuration source according to the combination policy information.

2. The method of claim 1, wherein obtaining source information according to the policy identifier comprises:
querying policy information corresponding to the policy identifier among stored corresponding relationships between the policy identifier and the policy information, wherein the policy information comprises the source information and engine information.

3. The method of claim 1, wherein obtaining the combination policy information according to the policy identifier comprises:
querying policy information corresponding to the policy identifier among stored corresponding relationships between the policy identifier and the policy information; and
querying the combination policy information according to the policy information.

4. The method of claim 1, wherein searching for the corresponding configuration sources according to the source information comprises:
sending a configuration source query request carrying the source information;
receiving aggregated configuration sources returned in response to the configuration source query request; and
forming a configuration source collection.

5. The method of claim 4, wherein the combination policy information comprises engine information, and combining the configuration sources into the uniform configuration source according to the combination policy information comprises:
combining the configuration sources according to a combination algorithm corresponding to the engine information and combination rules in the combination policy information.

6. The method of claim 5, further comprising:
buffering combination results.

7. The method of claim 1, further comprising:
receiving an event listening identifier from the user;
registering according to the event listening identifier and performing event monitoring after the configuration sources are combined into a uniform configuration source;
determining preset conditions in the event listening identifier are fulfilled; and
notifying the user.

8. The method of claim 7, wherein the preset conditions comprise at least one of:
configuration source changes and configuration changes due to an invocation of a configuration modification interface.

9. The method of claim 8, wherein the preset conditions comprise the configuration source changes, the method further comprising:
sending updated configuration information the user; and
causing the user load the configuration according to the updated configuration information.

10. A configuration information processing apparatus, comprising:
a policy identifier receiving unit adapted to receive a policy identifier representing configuration information requested by a user;
an information obtaining unit adapted to obtain corresponding source information and combination policy information according to the policy identifier;
a configuration source querying unit adapted to query and obtain configuration sources according to the source information corresponding to the policy identifier; and
a configuration source combining unit adapted to combine the configuration sources into a uniform configuration source according to the combination policy information obtained by the information obtaining unit.

11. The apparatus of claim 10, further comprising:
a policy storing unit adapted to store the combination policy information carrying combination rules;
a resource search control unit adapted to receive the source information obtained by the information obtaining unit, and forward the source information;
a configuration source storing unit adapted to receive the source information, store the configuration sources and the uniform configuration source; and
a configuration source feedback unit adapted to feed back the uniform configuration source to the user requesting the configuration source.

12. The apparatus of claim 11, further comprising
a listening identifier receiving unit adapted to receive an event listening identifier from the user, and send the event listening identifier to an event monitoring unit; and
an event monitoring unit adapted to monitor a configuration event according to the event listening identifier, determine the configuration event fulfills preset conditions in the event listening identifier, and request the configuration source feedback unit feed back current configuration source to the user.

13. The apparatus according to claim 10, the configuration source combining unit further comprising:
an initializing unit adapted to perform initialization according to the combination policy information;
a data access unit adapted to obtain data to be combined from the configuration source, and transmit the data;
a combination executing unit adapted to receive the data, combine the data according to the combination policy information; and
a combination control unit adapted to detect the combination of the data, and generate a result indicating the completion of the combination.

14. A platform system, comprising:
a user operation interface adapted to receive a configuration request carrying a policy identifier from a user;
a configuration information processing apparatus adapted to combine configuration sources carrying configuration information into a uniform configuration source according to the policy identifier in the configuration request; and
a configuration generating unit adapted to develop or customize platform configuration information requested by the user according to the uniform configuration source.

15. The system of claim 14, the configuration information processing apparatus further comprising:
a policy identifier receiving unit adapted to receive the policy identifier representing the configuration information requested by the user;
an information obtaining unit adapted to obtain corresponding source information and combination policy information according to the policy identifier;
a configuration source querying unit adapted to query and obtain the corresponding configuration sources according to the source information; and
a configuration source combining unit adapted to combine the configuration sources into a uniform configuration source according to the combination policy information.

16. The system of claim 14, the configuration generating unit further comprising:
a configuration customizing unit adapted to configure the uniform configuration source obtained from the configuration source combining unit requested by the user;
a configuration encapsulating unit adapted to encapsulate a configured functional module to generate an ultimate configuration file; and
a configuration outputting unit adapted to output the ultimate configuration file.

17. A computer readable medium comprising computer program codes stored thereon, executable by one or more digital processors for providing system configurations, the computer program codes including:
instructions for receiving from a user a policy identifier indicative of configuration information requested by the user;
instructions for obtaining source information and combination policy information according to the policy identifier;
instructions for searching for corresponding configuration sources according to the source information; and
instructions for combining the configuration sources into a uniform configuration source according to the combination policy information.

18. The computer readable medium of claim 17, the computer readable medium comprises:
Read-Only Memory (ROM) and magnetic disk or Compact Disk (CD).

19. The method of claim 6, further comprising sending the combination results to the user.
